(19) United States
(12) Patent Application Publication
(10) Pub. No.: US 2024/0399922 A1
(43) Pub. Date: Dec. 5, 2024

(54) VEHICLE CONTROL DEVICE

(71) Applicant: TOYOTA JIDOSHA KABUSHIKI KAISHA, Toyota-shi (JP)

(72) Inventors: Toshiya HASHIMOTO, Miyoshi-shi (JP); Masato MAEMURA, Nisshin-shi (JP); Ryosuke IKEMURA, Susono-shi (JP); Shogo TSUGE, Fuji-shi (JP)

(73) Assignee: TOYOTA JIDOSHA KABUSHIKI KAISHA, Toyota-shi (JP)

(21) Appl. No.: 18/616,648

(22) Filed: Mar. 26, 2024

(30) Foreign Application Priority Data
Jun. 2, 2023 (JP) 2023-091924

(51) Int. Cl. B60L 55/00; B60L 58/13

(52) U.S. Cl. CPC B60L 55/00; B60L 58/13; B60L 2260/54

(57) ABSTRACT

A vehicle control device according to the present disclosure is a vehicle control device that receives or transmits electric power to a power supply lane provided on a roadside portion and controls a vehicle traveling on the road, the vehicle control device including a processor, wherein the processor judges whether or not there is leeway in electric power in a vehicle provided with the vehicle control device when a power shortage occurs in a power supply area by the power supply lane, and supplies electric power stored in the vehicle to the power supply lane when it is judged that there is leeway in electric power.

### CROSS-REFERENCE TO RELATED APPLICATION

This application claims priority to Japanese Patent Application No. 2023-091924 filed on Jun. 2, 2023, incorporated herein by reference in its entirety.

### BACKGROUND

### 1. Technical Field

The present disclosure relates to a vehicle control device.

### 2. Description of Related Art

Japanese Unexamined Patent Application Publication No. 2021-83143 (JP 2021-83143 A) discloses a technology for controlling power transmission between a power transmission device provided on a road and a vehicle that is traveling. In JP 2021-83143 A, a control device acquires regenerative power generated in the vehicle, identifies an upper limit value of electric power that the battery can further accept in addition to the regenerative power based on the regenerative power and maximum charging power of a battery that the vehicle is equipped with, and suppresses reception of excessive electric power by suppressing electric power transmitted from the power transmission device to the vehicle to less than the upper limit value.

### SUMMARY

However, there are cases in which simply controlling the amount of electric power received at an own vehicle may not be sufficient to stabilize electric power balance in the entirety of a power transmission system that includes a power supply lane in which the own vehicle travels and other power supply lanes.

The present disclosure has been made in view of the above, and an object thereof is to provide a vehicle control device that is capable of stabilizing an electric power balance in the entirety of a power supply system.

A vehicle control device according to the present disclosure is a vehicle control device that receives or transmits electric power from or to a power supply lane provided on a roadside portion of a road and controls a vehicle traveling on the road, the vehicle control device including a processor.

The processor judges, when a power shortage occurs in a power supply area of the power supply lane, whether there is leeway in electric power in the vehicle in which the vehicle control device is installed, and supplies electric power stored in the vehicle to the power supply lane when judging that there is leeway in the electric power.

According to the present disclosure, in a power transmission system, an electric power balance can be stabilized in the entirety of the power supply system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a wireless power transfer system including a vehicle control device according to an embodiment;

FIG. 2 is a diagram for explaining a power supply lane;

FIG. 3 is a block diagram for explaining a functional configuration of a vehicle in the vehicle control device according to the embodiment;

FIG. 4 is a flowchart illustrating a flow of electric power control in a vehicle;

FIG. 5 is a flow chart showing a flow of electric power control in vehicles according to Modification 1; and

FIG. 6 is a flowchart illustrating a flow of electric power control in a vehicle according to Modification 2.

### DETAILED DESCRIPTION OF EMBODIMENTS

A vehicle control device according to an embodiment of the present disclosure will be described with reference to the drawings. Incidentally, the constituent elements in the following embodiments include those that can be easily replaced by a person skilled in the art or those that are substantially the same.

### Embodiments

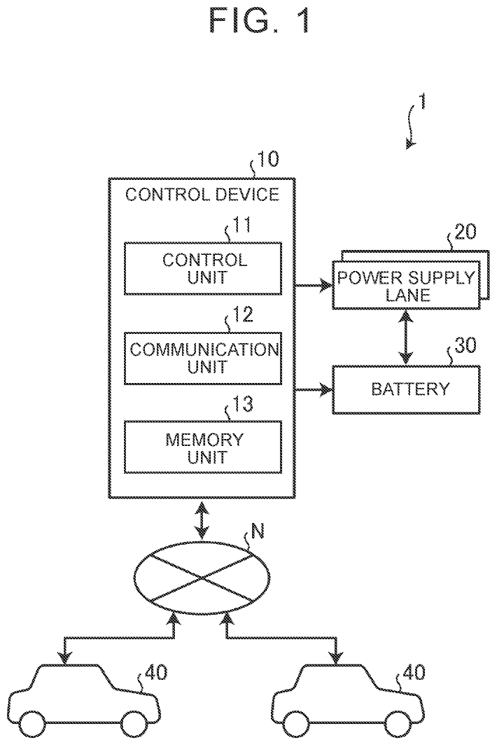

A wireless power transfer system where the vehicle control device according to the embodiment is applied will be described referring to FIG. 1 to FIG. 3.

FIG. 1 is a schematic diagram illustrating a wireless power transfer system including a vehicle control device according to an embodiment. The wireless power transfer system 1 performs wireless power transmission from the power supply lane 20 to the vehicle 40 by, for example, magnetic field resonance coupling (magnetic field resonance). The wireless power transfer system 1 includes a control device 10, a power supply lane 20, a battery 30, and a vehicle 40. The vehicles 40 are, for example, electrified vehicle capable of charging electric power supplied from an external power source, and are, for example, battery electric vehicle (BEV), plug-in hybrid electric vehicle (PHEV), and the like. The vehicle 40 may be a manual driving vehicle or an automatic driving vehicle. In addition, the vehicles 40 include a communication unit (for example, a Data Communication Module (DCM)) for communicating with the control device 10.

The wireless power transfer system 1 performs wireless power transmission from the power supply lane 20 to the vehicle 40 by magnetic field resonance coupling (magnetic field resonance).

The wireless power transfer system 1 transmits electric power to a vehicle 40 traveling on a power supply lane 20 disposed on a road in a non-contact manner. That is, the wireless power transfer system 1 transmits electric power by a magnetic field resonance method, and realizes power supply during traveling to the vehicle 40 by using magnetic field resonance coupling (magnetic field resonance). The wireless power transfer system I can be represented as a dynamic wireless power transmission (D-WPT) system or a magnetic field dynamic wireless power transmission (MF-D-WPT) system.

The control device 10 and the vehicle 40 each have a communication function and are configured to be able to communicate with each other through the network N. The network N includes, for example, an Internet network, a mobile telephone network, a WiFi (registered trademark, Wireless Fidelity), a BLE (Bluetooth (registered trademark) Low Energy), and the like.

The control device 10 exchanges various kinds of information with the vehicle 40 and controls the power supply lane 20 and the battery 30. The control device 10 includes a control unit 11, a communication unit 12, and a storage unit 13.

Specifically, the control unit 11 includes a processor including Central Processing Unit (CPU), Digital Signal Processor (DSP), Field-Programmable Gate Array (FPGA), Graphics Processing Unit (GPU), and the like, and a memory (main storage unit) including Random Access Memory (RAM), Read Only Memory (ROM), and the like.

The control unit 11 loads a program stored in the storage unit 13 into a work area of the main storage unit and executes the program, and controls each component and the like through execution of the program, thereby realizing a function that matches a predetermined purpose.

The communication unit 12 includes, for example, a communication module capable of transmitting and receiving various types of information. The communication unit 12 communicates with the vehicle 40 through, for example, the network N to transmit and receive various types of information when electric power is supplied from the power supply lane 20 to the vehicle 40 or when the power supply lane 20 is supplied with electric power from the vehicle 40.

The storage unit 13 includes, for example, Erasable Programmable ROM (EPROM), Hard Disk Drive (HDD), and a recording medium such as a removable medium. Examples of the removable medium include disc recording media such as Universal Serial Bus (USB) memories, Compact Disc (CD), Digital Versatile Disc (DVD), Blu-ray (registered trademark) Disc (BD). The storage unit 13 can store Operating System (OS), various programs, various tables, various databases, and the like.

The storage unit 13 stores, for example, various types of information exchanged with the vehicle 40, information on the remaining capacity of the battery 30, and the like.

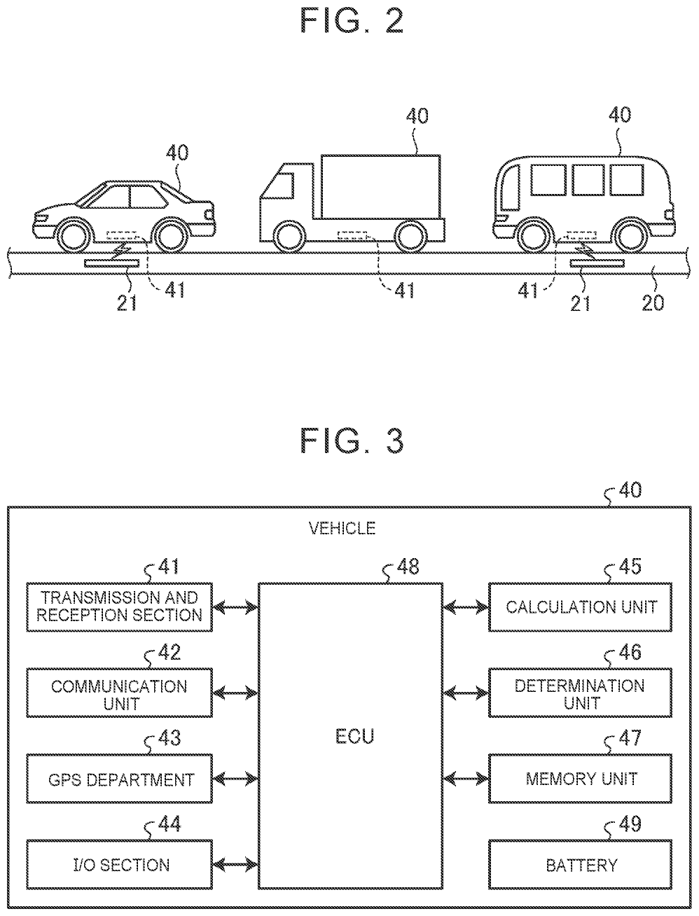

FIG. 2 is a diagram for explaining a power supply lane. In the present embodiment, as shown in FIG. 2, the shape of the vehicle and the like may be different as long as they have a common function.

The power supply lane 20 is configured to supply electric power to the vehicle 40 in a non-contact manner and to receive electric power from the vehicle 40 in a non-contact manner. Specifically, the power supply lane 20 includes an energization unit 21 including a coil that supplies or receives electric power to or from the vehicle 40. The energization unit 21 is embedded in a lane of a road. The energization unit 21 may be formed by integrating a power-supplying coil and a power-receiving coil, or may be provided separately.

The battery 30 is a stationary power storage device. When the power supply lane 20 functions as a power transmission lane, the battery 30 supplies electric power to the power supply lane 20. When the power supply lane 20 functions as a power reception lane, the battery 30 receives electric power from the power supply lane 20 and stores the electric power. Further, the battery 30 may be supplied with electric power from an external power generation facility, or may be supplied with electric power to an external consumer facility. Although only one battery 30 is illustrated in FIG. 1, the battery 30 may be provided for each power supply lane 20.

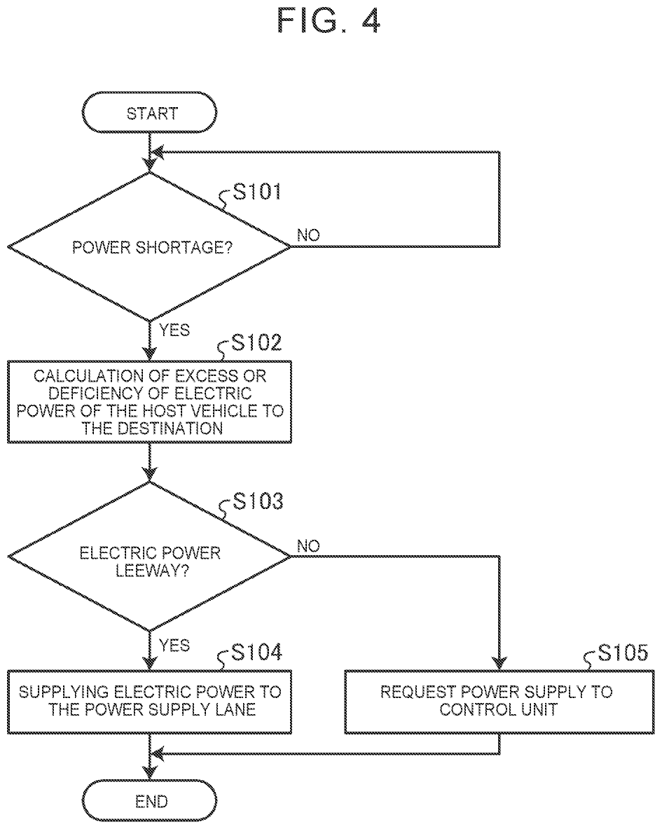

Next, the configuration of the vehicle 40 will be described with reference to FIGS. 1 and 3. FIG. 3 is a block diagram for explaining a functional configuration of a vehicle in the vehicle control device according to the embodiment. In the vehicle 40, the battery 49 is charged by electric power supplied from the energization unit 21 managed by the control device 10.

The vehicle 40 includes a transmission/reception unit 41, a communication unit 42, a Global Positioning System (GPS) unit 43, an input/output unit 44, a calculation unit 45, a determination unit 46, a storage unit 47, and an Electronic Control Unit (ECU) 48. Further, the vehicle 40 is provided with a battery 49 that supplies electric power to each unit. The battery 49 is a power storage device and is configured to be chargeable. The components for controlling the vehicles 40 are configured by using one or a plurality of computers including a CPU, FPGA, ROM, a RAM, and the like.

The transmission/reception unit 41 functions as a reception unit that receives a power supply signal from the energization unit 21. In addition, the transmission/reception unit 41 functions as a transmission unit that transmits a power supply signal to the energization unit 21.

The communication unit 42 performs communication with each external device by wireless communication via the network N. The communication unit 42 receives, from an external device, road traffic information such as regulations and traffic congestion, and information related to a disaster.

GPS unit 43 receives radio waves from GPS satellites and detects the position of the vehicles 40. The detected position is output to the outside as position information of the vehicle 40 or stored in the storage unit.

The input/output unit 44 includes a touch panel display, a speaker, a microphone, and the like. The input/output unit 44 is configured to be capable of outputting information, such as displaying characters, figures, and the like on a screen of a touch panel display, outputting sound from a speaker, and the like, under the control of ECU 48. In addition, the input/output unit 44 is configured to allow a user of the vehicle 40 or the like to operate the touch panel display or to emit sound toward the microphone, thereby inputting predetermined data to ECU 48.

The calculation unit 45 calculates the electric power consumption required to reach the destination when a power shortage occurs or is predicted to occur in the jurisdictional range of the wireless power transfer system 1.

The determination unit 46 determines whether or not there is leeway in electric power based on the electric power consumption calculated by the calculation unit 45 and the remaining charge in the battery 49. The remaining charge is, for example, State Of Charge (SOC).

The storage unit 47 is configured by using a computer-readable recording medium, and stores various programs and various data in a writable and readable manner. The recording medium includes a storage medium such as a hard disk, a semiconductor memory, an optical disk, a flash memory, and a magnetic disk, and a drive device of the storage medium. The storage unit 47 stores an operating system (OS) and programs of various applications required for ECU 48 to comprehensively control the operations of the respective units of the vehicles 40.

ECU 48 includes an information processing device such as a microcomputer including a CPU, FPGA, ROM, a RAM, and the like. ECU 48 comprehensively controls the electric operations of the respective units of the vehicles 40. ECU 48 is configured to perform an operation using inputted data, data stored in advance, and a program, and output the operation result as a control command signal.

The vehicle 40 includes a drive mechanism and an operation mechanism for driving the vehicle 40. Specifically, the vehicle 40 includes a powertrain and drive wheels as drive mechanisms. The powertrain includes a power source that generates a driving force and outputs the driving force from an output shaft, and a power transmission mechanism that transmits the driving force output from the power source to the driving wheels 2. The operation mechanism includes a shift lever, an accelerator pedal, and the like. When autonomous driving of the vehicles 40 is performed, the respective units are driven in accordance with an instruction under the control of ECU 48.

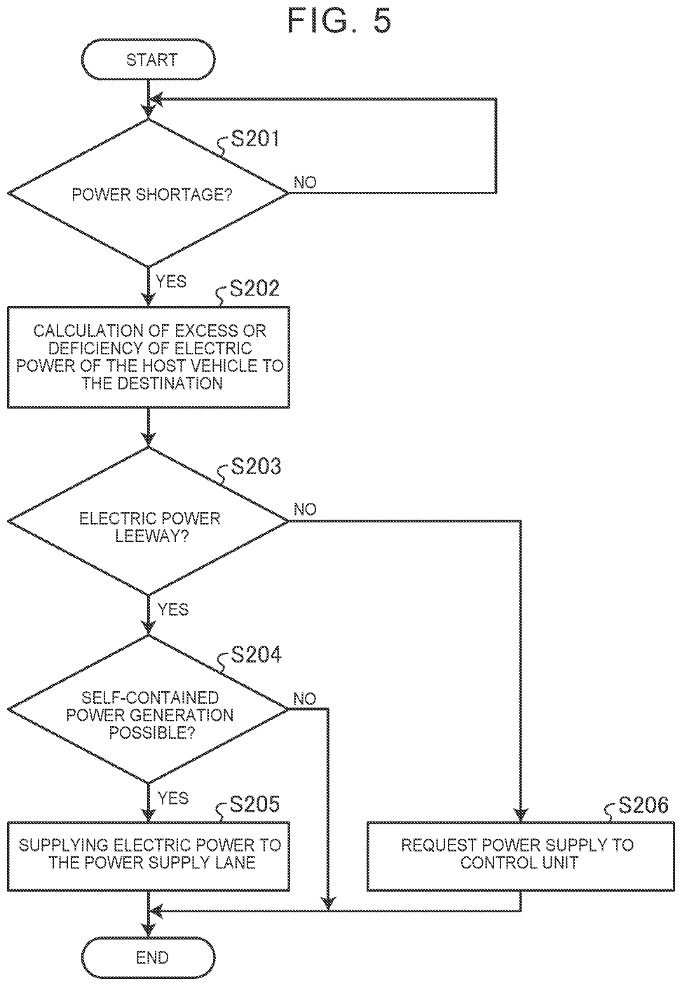

Here, in the present embodiment, the electric power to be transmitted between the vehicle 40 and the power supply lane 20 is controlled based on the electric power state of the host vehicle. This electric power control will be described with reference to FIG. 4. FIG. 4 is a flowchart illustrating a flow of electric power control in the vehicle. This electric power control is performed, for example, just before the vehicles enter the power supply lane 20, for example, at a position in which the distance to the entrance of the power supply lane 20 is several km. Further, this electric power control is performed on the power supply lane 20 through which the vehicle enters. That is, the power supply control is executed in each of the power supply lanes in which the vehicle is scheduled to enter.

First, in this electric power control, ECU 48 determines whether a power shortage has occurred or is expected to occur in the near future under the control of the wireless power transfer system 1 (power supply area by the power supply lane 20) (S101). ECU 48 acquires information on electric power via the communication unit 32 and determines whether or not there is a power shortage. At this time, a power shortage is predicted taking into consideration, for example, the state of electric power use by air conditioning, and the emergency vehicle is excluded from the target. When ECU 48 judges that the power shortage has not occurred (S101: No), it repeats the judgment of whether the power shortage has occurred. On the other hand, if ECU 48 judges that a power shortage has occurred or is expected to occur (S101: Yes), it transitions to S102.

In S102, the calculation unit 45 calculates the excess or deficiency of the electric power to the set destination in the host vehicle. Here, for example, the calculation unit 45 first calculates the traveling distance from the route to the destination, multiplies by a coefficient related to the preset electric power consumption, and calculates the electric power consumption required to the destination. Thereafter, the calculation unit 45 calculates a difference (electric power consumption-electric power remaining amount) between the calculated electric power consumption and the electric power remaining amount of the host vehicle. In the present embodiment, the difference is defined as excess or deficiency. The difference indicates that the electric power is sufficient if the difference is a positive value, and indicates that the electric power is insufficient if the difference is a negative value.

After calculating the excess or deficiency of the electric power, the determination unit 46 determines whether or not there is leeway in the electric power (S103).

In this step, the determination unit 46 judges that there is leeway in electric power if the difference is larger than a preset threshold value, and judges that there is no leeway in electric power if the difference is equal to or smaller than the threshold value. If the determination unit 46 judges that there is no leeway in electric power (S103: No), the process proceeds to S105. On the other hand, when the determination unit 46 judges that there is leeway in electric power (S103: Yes), the process proceeds to S104. Note that the threshold value is set to a value in which the battery 49 of the vehicle 40 has power equal to or higher than a predetermined amount of electric power at the stage of being delivered to the destination.

In S104, ECU 48 performs electric power control to provide power to the power supply lane 20. In this step, electric power is supplied (reverse power transmission) from the vehicle 40 to the power supply lane 20. At this time, ECU 48 sets the feed rate based on the calculated difference. For example, ECU 48 supplies electric power (amount) obtained by subtracting a preset electric power amount from the difference, and the electric power stored by the battery 49 of the vehicle 40 to the power supply lane 20 via the energization unit 21.

In addition, in S105, the control device 10 is required for power supply. In this step, electric power is supplied from the power supply lane 20 to the vehicle 40 via the energization unit 21.

In the present embodiment described above, since the vehicle 40 in which the remaining amount of the battery 320 has leeway with respect to the electric power required to reach the destination causes the electric power to be reversely transmitted from the vehicle 40 to the power supply lane 20, the balance of the electric power amount between the vehicles 40 traveling in the range controlled by the system is adjusted. According to the present embodiment, it is possible to stabilize the electric power balance in the entire wireless power transfer system 1 by adjusting the balance of the amount of electric power between the vehicles 40.

In the embodiment, whether or not there is leeway in electric power is determined based on the remaining power (SOC) of the battery 320, but the present disclosure is not limited thereto. For example, electric power control of the host vehicle can be performed as follows.

### Modification 1

Next, Modification 1 of the present embodiment will be described with reference to FIG. 5. FIG. 5 is a flowchart illustrating a flow of electric power control in a vehicle according to Modification 1. Since the configuration of the system is the same as that of the wireless power transfer system 1 according to the embodiment, the description thereof will be omitted.

In the electric power control according to the first modification, ECU 48 determines whether or not a power shortage has occurred or is expected to occur in the near future under the control of the wireless power transfer system 1 (S201). When ECU 48 judges that the power shortage has not occurred (S201: No), it repeats the judging of whether the power shortage has occurred. On the other hand, if ECU 48 judges that a power shortage has occurred or is expected to occur (S201: Yes), it transitions to S202.

In S202, the calculation unit 45 calculates, in the same manner as in S102, the excess or deficiency of the electric power to the set destination in the host vehicle.

After calculating the excess or deficiency of the electric power, the determination unit 46 determines whether or not there is leeway in the electric power (S203). If the determination unit 46 judges that there is no leeway in electric power (S203: No), the process proceeds to S206. On the other hand, when the determination unit 46 judges that there is leeway in electric power (S203: Yes), the process proceeds to S204. Note that the threshold value is set to a value in which the battery 49 of the vehicle 40 has power equal to or higher than a predetermined amount of electric power at the stage of being delivered to the destination.

In S204, ECU 48 determines whether or not the host vehicle is a vehicle capable of self-contained power generation. At this time, ECU 48 determines that the own vehicle is capable of self-contained power generation, for example, in a Hybrid Electric Vehicle (HEV where the own vehicle includes an engine and a motor and can charge the battery 49 by power generation inside the vehicle. When ECU 48 corresponds to a vehicle capable of self-contained power generation (S204: Yes), the process proceeds to S205. On the other hand, when ECU 48 corresponds to a vehicle that is not capable of self-contained power generation (S204: No), the process ends.

In S205, ECU 48 performs electric power control to provide power to the power supply lane 20. In this step, electric power is supplied (reverse power transmission) from the vehicle 40 to the power supply lane 20.

In addition, in S206, the control device 10 is requested for power supply. In this step, electric power is supplied from the power supply lane 20 to the vehicle 40 via the energization unit 21.

In Modification 1 described above, since the vehicle 40 in which the remaining amount of the battery 320 has leeway with respect to the electric power required to reach the destination causes the electric power to be reversely transmitted from the vehicle 40 to the power supply lane 20, the balance of the electric power amount between the vehicles 40 traveling in the range controlled by the system is adjusted. According to the first modification, the electric power balance in the entire wireless power transfer system 1 can be stabilized by the balance adjustment of the amount of electric power between the vehicles 40.

Further, according to the first modification, with respect to the vehicle 40 that cannot be charged to the battery 49 by self-contained power generation, since reverse power transmission to the power supply lane 20 is prevented, it is possible to perform electric power adjustment according to the characteristics of the vehicle 40.

### Modification 2

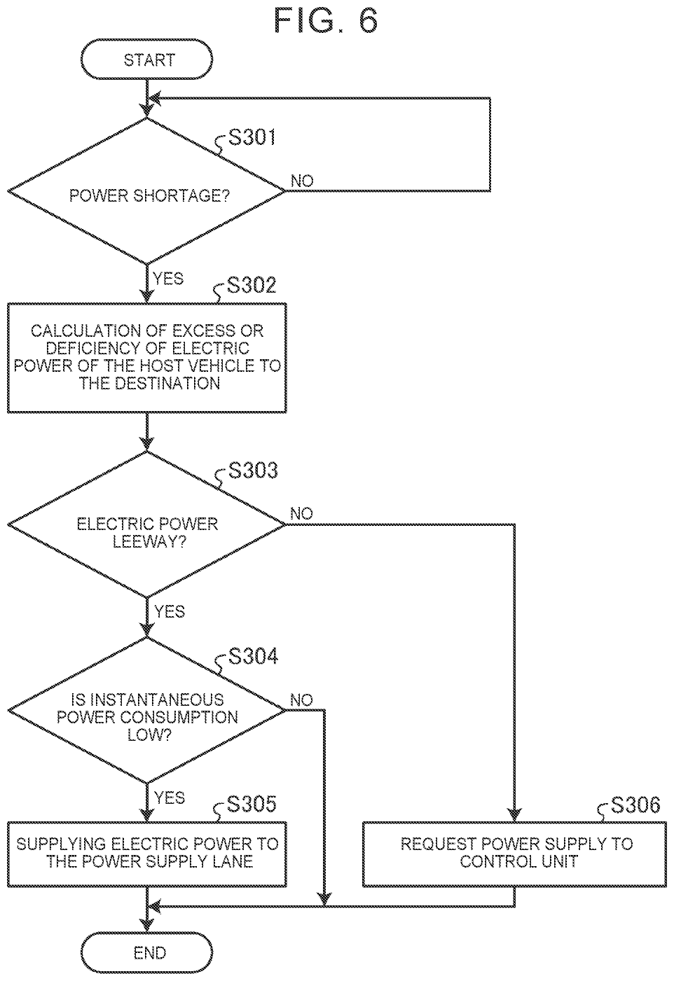

Next, Modification 2 of the present embodiment will be described with reference to FIG. 6. FIG. 6 is a flowchart illustrating a flow of electric power control in a vehicle according to Modification 2. Since the configuration of the system is the same as that of the wireless power transfer system 1 according to the embodiment, the description thereof will be omitted.

In the electric power control according to Modification 2, ECU 48 determines whether or not a power shortage has occurred or is expected to occur in the near future under the control of the wireless power transfer system 1 (S301). When ECU 48 judges that the power shortage has not occurred (S301: No), it repeats the judging of whether the power shortage has occurred. On the other hand, if ECU 48 judges that a power shortage has occurred or is expected to occur (S301: Yes), it transitions to S302.

In S302, the calculation unit 45 calculates, in the same manner as in S102, the excess or deficiency of the electric power to the set destination in the host vehicle.

After calculating the excess or deficiency of the electric power, the determination unit 46 determines whether or not there is leeway in the electric power (S303). If the determination unit 46 judges that there is no leeway in electric power (S303: No), the process proceeds to S306. On the other hand, when the determination unit 46 judges that there is leeway in electric power (S303: Yes), the process proceeds to S304. Note that the threshold value is set to a value in which the battery 49 of the vehicle 40 has power equal to or higher than a predetermined amount of electric power at the stage of being delivered to the destination.

In S304, ECU 48 determines whether or not the host vehicle is a vehicle that has low instantaneous power consumption. At this time, the lower the speed, the lower the instantaneous power consumption. At this time, the criterion for judging the low speed is set based on, for example, a speed at which the instantaneous power consumption is low, such as a speed at the time of traffic jam. For example, ECU 48 determines that the instantaneous power consumption is low when the host vehicle is traveling at a low speed. ECU 48 proceeds to S305 when it is judged that the vehicle corresponds to a vehicle that has low instantaneous power consumption (S304: Yes). On the other hand, when ECU 48 judges that the vehicle does not correspond to the vehicle with low instantaneous power consumption (S304: No), the process ends.

In addition to the instantaneous power consumption, the magnitude of the electric power consumption may be judged based on the average vehicle speed.

In S305, ECU 48 performs electric power control to provide power to the power supply lane 20. In this step, electric power is supplied (reverse power transmission) from the vehicle 40 to the power supply lane 20.

In addition, in S306, the control device 10 is requested for power supply. In this step, electric power is supplied from the power supply lane 20 to the vehicle 40 via the energization unit 21.

In Modification 2 described above, since the vehicle 40 in which the remaining amount of the battery 320 has leeway with respect to the electric power required to reach the destination causes the electric power to be reversely transmitted from the vehicle 40 to the power supply lane 20, the balance of the electric power amount between the vehicles 40 traveling in the range controlled by the system is adjusted. According to the second modification, the electric power balance in the entire wireless power transfer system 1 can be stabilized by the balance adjustment of the amount of electric power between the vehicles 40.

Further, according to the second modification, since the reverse power transmission to the power supply lane 20 is not performed according to the magnitude of the instantaneous power consumption, it is possible to perform the electric power adjustment according to the electric power consumption state of the vehicle 40.

Further advantages and variations can be readily derived by one of ordinary skill in the art. Thus, the broader aspects of the disclosure are not limited to the specific details and representative embodiments presented and described above. Accordingly, various modifications may be made without departing from the spirit or scope of the general inventive concept as defined by the appended claims and their equivalents.

What is claimed is:

1. A vehicle control device that receives or transmits electric power from or to a power supply lane provided on a roadside portion of a road and controls a vehicle traveling on the road, the vehicle control device comprising a processor, wherein the processor judges, when a power shortage occurs in a power supply area of the power supply lane, whether there is leeway in electric power in the vehicle in which the vehicle control device is installed, and supplies electric power stored in the vehicle to the power supply lane when judging that there is leeway in the electric power.

2. The vehicle control device according to claim 1, wherein the processor judges whether there is leeway in electric power, based on predicted electric power consumption until the vehicle arrives at a destination set for the vehicle in which the vehicle control device is installed, and a remaining charge.

3. The vehicle control device according to claim 1, wherein the processor judges whether the vehicle in which the vehicle control device is installed is a vehicle capable of self-contained power generation, and judges that there is leeway in the electric power when judging that the vehicle is the vehicle capable of self-contained power generation.

4. The vehicle control device according to claim 1, wherein the processor judges whether the vehicle in which the vehicle control device is installed is a vehicle with low instantaneous power consumption, and judges that there is leeway in the electric power when judging that the vehicle is the vehicle with low instantaneous power consumption.
